(19) United States
(12) Patent Application Publication
(10) Pub. No.: US 2015/0310502 A1
(43) Pub. Date: Oct. 29, 2015

(54) SYSTEMS AND METHODS FOR SELECTING, SERVING, AND DISPLAYING ADVERTISEMENT CONTENT BASED ON A POINT OF INTEREST

(71) Applicants: Xinyu Tang, Cupertino, CA (US); Tao Huang, Cupertino, CA (US); Charles Chapin, San Jose, CA (US)

(72) Inventors: Xinyu Tang, Cupertino, CA (US); Tao Huang, Cupertino, CA (US); Charles Chapin, San Jose, CA (US)

(73) Assignee: GOOGLE INC., Mountain View, CA (US)

(21) Appl. No.: 13/344,739

(22) Filed: Jan. 6, 2012

(51) Int. Cl. G06Q 30/02

(52) U.S. Cl. CPC G06Q 30/0275

(57) ABSTRACT

A computer-implemented method that includes obtaining a bid-parameter-set specifying a point of interest group indicative of one or more geographic points of interest, receiving a request for an advertisement corresponding to a geographic point of interest, the request generated in response to user interaction with graphically displayed content corresponding to a geographic point of interest, determining, using a computer, whether the geographic point of interest corresponds to at least one of the one or more geographic points of interest of the point of interest group, and submitting to an auction for selecting an advertisement to serve the request for an advertisement, in response to at least determining that the geographic point of interest corresponds to at least one of the one or more geographic points of interest, an auction bid corresponding to the bid-parameter-set.

### BACKGROUND OF THE INVENTION

1. Field of the Invention

This invention relates generally to providing content and more particularly to identifying and serving advertisement content.

2. Description of the Related Art

Advertisements are often used to persuade an audience to take some action with regard to products, services, ideals and so forth. An advertisement may include promotional content that is intended to influence one or more persons' behavior. For example an advertisement may be intended to cause a person to purchase a particular product or service. Advertisements are often presented via various forms of media, such as newspapers, magazines, television, radio, physical creatives (e.g., billboards, signs, posters, etc.), or electronic media (e.g., websites, e-mails, text messages, etc.). With the advent of the Internet, many advertisement campaigns rely heavily on the use of on-line advertisements. On-line advertisements may include banners, videos, pop-up ads and so forth that are displayed in association with a webpage. On-line advertisements are often provided to a webpage for display via an advertisement provider/network that manages distribution of ads to various webpages.

Advertisements are usually paid for by advertisers, such as a business selling the advertised products and services. Advertisers often pay an advertisement provider/network a given fee based on the number of times advertisements are displayed and/or based on how users interact with the advertisements. For example, an advertiser may pay a fee of $0.10 each time their on-line ad is clicked by a user. In some instance, a website hosting a webpage displaying the ad may receive a share of the payment for the advertisement.

Unfortunately, the cost associated with on-line advertising can be substantial. As a result, advertisers are generally interested in techniques to improve the effectiveness of their advertisements. In some instances, advertisers target on-line advertisements to an audience that is more likely to be persuaded to take a desired action associated with the advertisement. For example, advertisers may provide targeted advertisements to certain users based on demographics of the user, actions taken by the user and so forth. Although these techniques may be somewhat helpful, they may not enable advertisers to effectively regulate how and where their advertisements are being distributed.

### SUMMARY OF THE INVENTION

Various embodiments of methods and apparatus for serving content are provided herein. In some embodiments, provided is a computer-implemented method that includes obtaining a bid-parameter-set specifying a point of interest group indicative of one or more geographic points of interest, receiving a request for an advertisement, the request generated in response to user interaction with graphically displayed content corresponding to a geographic point of interest, determining, using a computer, whether the geographic point of interest corresponds to at least one of the one or more geographic points of interest of the point of interest group, and submitting to an auction for selecting an advertisement to serve the request for an advertisement, in response to at least determining that the geographic point of interest corresponds to at least one of the one or more geographic points of interest, an auction bid corresponding to the bid-parameter-set.

In some embodiments, provided is a non-transitory computer readable storage medium having computer-executable program instructions stored thereon, that are executable by a computer to cause steps including obtaining a bid-parameter-set specifying a point of interest group indicative of one or more geographic points of interest, receiving a request for an advertisement, the request generated in response to user interaction with graphically displayed content corresponding to a geographic point of interest, determining, using a computer, whether the geographic point of interest corresponds to at least one of the one or more geographic points of interest of the point of interest group, and submitting to an auction for selecting an advertisement to serve the request for an advertisement, in response to at least determining that the geographic point of interest corresponds to at least one of the one or more geographic points of interest, an auction bid corresponding to the bid-parameter-set.

In some embodiments, provided is an advertisement-server (ad-server) system including a processor, a memory and an auction module stored on the memory. The auction module to be executed by the processor to cause obtaining a bid-parameter-set specifying a point of interest group indicative of one or more geographic points of interest, receiving a request for an advertisement, the request generated in response to user interaction with graphically displayed content corresponding to a geographic point of interest, determining, using a computer, whether the geographic point of interest corresponds to at least one of the one or more geographic points of interest of the point of interest group, and submitting to an auction for selecting an advertisement to serve the request for an advertisement, in response to at least determining that the geographic point of interest corresponds to at least one of the one or more geographic points of interest, an auction bid corresponding to the bid-parameter-set.

In some embodiments, provided is a computer-implemented method for auctioning an advertisement space. The method includes receiving a request for an advertisement, the request generated in response to user interaction with graphically displayed content corresponding to a geographic point of interest, and assessing a plurality of bid parameter sets. A first of the bid-parameter-sets includes a first point of interest group bid criteria indicative of a first set of one or more geographic points of interest for which a corresponding auction bid is to be submitted. A second of the bid-parameter-sets includes a second point of interest group bid criteria indicative of a second set of one or more geographic points of interest for which a corresponding auction bid is to be submitted. The method also includes determining that the geographic point of interest does correspond to at least one of the one or more geographic points of interest of the first set of one or more geographic points of interest for which a corresponding auction bid is to be submitted and determining that the geographic point of interest does not correspond to at least one of the one or more geographic points of interest of the second set of one or more geographic points of interest for which a corresponding auction bid is to be submitted. The method also includes submitting to an auction for selecting an advertisement to serve the request for an advertisement, in response to at least determining that the geographic point of interest does correspond to at least one of the one or more geographic points of interest of the first set of one or more geographic points of interest for which a corresponding auction bid is to be submitted, an auction bid corresponding to the first of the bid-parameter-sets, and excluding from submission to the auction for selecting an advertisement to serve the request for an advertisement, in response to at least determining that the geographic point of interest does not correspond to at least one of the one or more geographic points of interest of the second set of one or more geographic points of interest for which a corresponding auction bid is to be submitted, an auction bid corresponding to the second of the bid-parameter-sets.

### BRIEF DESCRIPTION OF THE DRAWINGS

FIG. 1 is a diagram that illustrates an advertising system in accordance with one or more embodiments of the present technique.

FIG. 2 is an illustration of an exemplary display of a webpage in accordance with one or more embodiments of the present technique.

FIG. 3 is a flowchart that illustrates a method of obtaining bid parameters, in accordance with one or more embodiments of the present technique.

FIG. 4 is a diagram that illustrates an exemplary bid parameter selection interface in accordance with one or more embodiments of the present technique.

FIG. 5 illustrates a table including a listing of exemplary bid-parameter-sets in accordance with one or more embodiments of the present technique.

FIG. 6 is a flowchart that illustrates a method for selecting, serving and displaying content in accordance with one or more embodiments of the present technique.

FIG. 7 is a diagram that illustrates an exemplary computer system in accordance with one or more embodiments of the present technique.

### DETAILED DESCRIPTION OF THE PREFERRED EMBODIMENTS

As discussed in more detail below, provided in some embodiments are systems and methods for selecting and/or serving on-line advertisements (e.g., ads). In some embodiments, an advertiser is afforded the opportunity to identify one or more points of interest (e.g., a point of interest group) for which they desire to have a corresponding one of their advertisement displayed. In certain embodiments, the point of interest group may specify one or more geographic points of interest (e.g., the Statue of Liberty). In some embodiments, upon detecting user interaction with content associated with a point of interest specified by the advertiser, a corresponding bid is submitted to an auction for selecting advertisement content to be displayed in association with the content associated with the point of interest.

In some embodiments, upon an indication of a user interacting with content associated with a given point of interest (e.g., via a webpage), a corresponding request for an ad (e.g., an ad-request) to be presented in an ad-space of a webpage is submitted an ad-server. In certain embodiments, the ad-server selects and/or serves an advertisement corresponding to the given point of interest. In certain embodiments, the ad-server conducts an auction for the ad-space. In certain embodiments, the ad-server considers a plurality of bids submitted, identifies one or more winning bids, and serves ads corresponding to the one or more winning bids to satisfy the ad-request.

In certain embodiments, an advertiser may specify bid-parameter-set including bid criteria indicative of when a bid should be submitted to the auction, a bid amount and/or an ad corresponding to the bid. In some embodiments, the bid criteria may specify a point of interest (POI) group indicative of one or more points of interest, wherein a corresponding bid for the bid-parameter-set is to be submitted to an ad-auction for an ad-space of a webpage when an ad-request relates to user interaction with content associated with one or more points of interest specified by the point of interest group. In certain embodiments, a bid corresponding to a given bid-parameter-set is submitted to an auction for the ad-space when the ad-request relates to user interaction with content associated with the one or more points of interest specified by the point of interest group. In some embodiments, a bid corresponding to a given bid-parameter-set is not submitted to an auction for the ad-space of a webpage when the ad-request does not relate to user interaction with the one or more points of interest specified by the point of interest group.

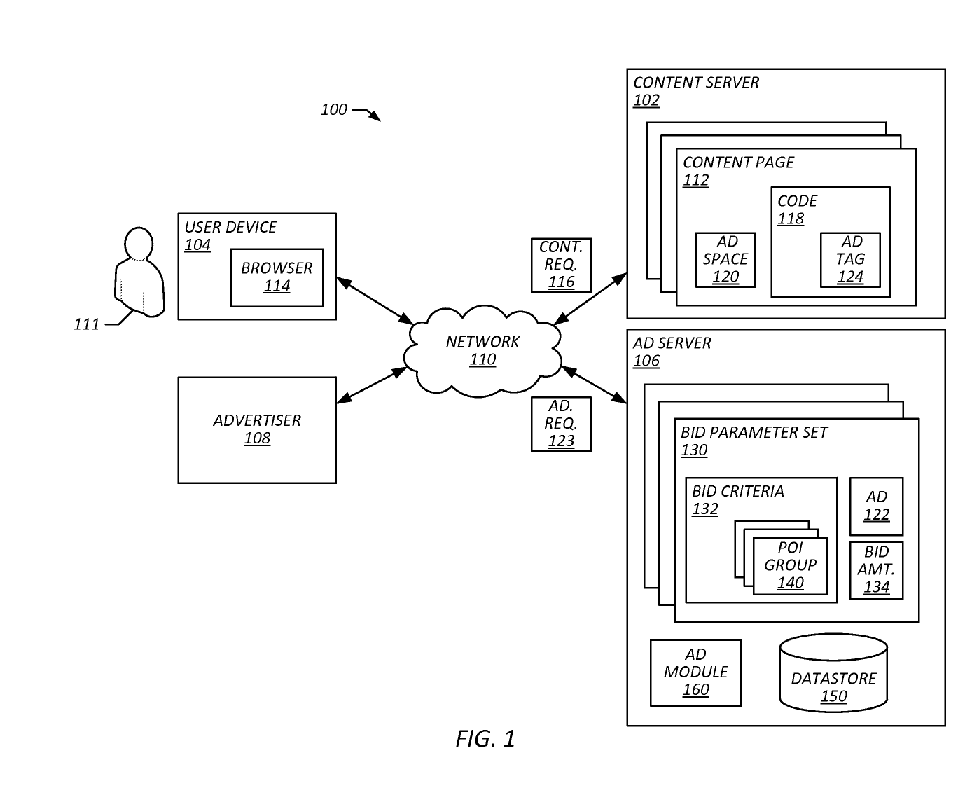

FIG. 1 is a diagram that illustrates an advertising system (“ad-system”) 100 in accordance with one or more embodiments of the present technique. Ad-system 100 may be implemented to present advertisements and/or other content to users. Ad-system 100 may include a content server 102, a user device 104, an ad-server 106 and an advertiser 108. In some embodiments, ad system 100 may serve or otherwise provide content (e.g., advertising content) for display to a user 111.

In some embodiments, entities of system 100 (e.g., content server 102, user device 104, ad-server 106 and advertiser 108) may be communicatively coupled via a network 110. Network 110 may include may include any element or system that facilitates communications between various network entities/nodes of system 100. For example, network 110 may facilitate communication between content server 102, user device 104, ad-server 106 and/or advertiser 108. Network 110 may include an electronic communication network, such as the Internet, a local area network (LAN), a wide area (WAN), a cellular communications network or the like. Network 110 may facilitate data exchange by way of packet switching using the Internet Protocol (IP). Network 110 may facilitate wired and/or wireless connectivity and communication. Network 110 may include a single network or combination of networks that facilitate communication between the entities of system 100.

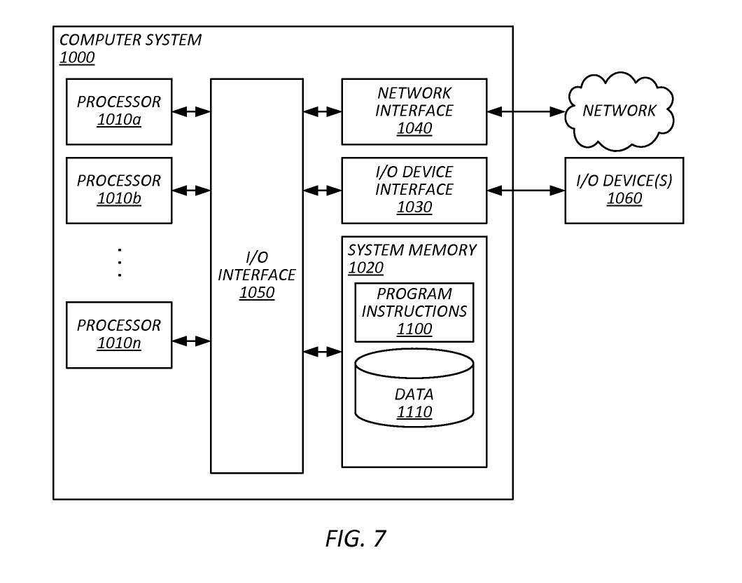

User device 104 may include any device capable of transmitting and/or receiving information via network 110. User device 104 may include a device employed by user 111 to interact with other entities/nodes coupled to network 110. User device 104 may include one or more of a personal computer (e.g., a desktop), a mobile computing device (e.g., a laptop computer), a cellular communication device (e.g., a cellular phone), a personal digital assistant (PDA), a media player/recorder, a game console, a television system, an audio system, a radio system, a navigation system, or the like. In some embodiments, user device 104 may include a wired or a wireless device. For example, user device 104 may include a cellular phone wirelessly connected to other devices via a cellular communications network. A wireless user device 104 may enable user 111 to access network 110, and entities connected thereto, from a variety of remote locations. User device 104 may include general computing components and/or embedded systems optimized with specific components for performing specific tasks. User device 104 may also include various other elements, such as processes running on various machines. User device 104 may include a program/application that can be used to generate a request for content, to provide content, to render content, and/or to send/receive request to other devices via network 110. For example, user device 104 may store and/or execute an Internet web-browser 114 or similar application. Such an application may be used to transmit and/or receive data and/or content via network 110, render data and/or content at user device 104, and/or enable user interaction with data and/or content via user device 104. User device 104 may include various input/output (I/O) interfaces. For example user device may include a graphical user interface (e.g., a display screen), an audible user interface (e.g., a speaker), printer, keyboard, a pointer device (e.g., mouse, trackball, touchpad, stylus), an audible interface (e.g., a microphone), or the like. In some embodiments, user device 104 may include a computer system similar to that of computer system 1000 described below with regard to at least FIG. 7.

Content server 102 may include an entity that provides content to various other entities and of ad system 100. Content server 102 may be operated by a content publisher, such as a website provider. Content server 102 may host a content site, such as a website, a file transfer protocol (FTP) site, or other source of content accessible via network 110. Although content server 102 is represented by a single box in FIG. 1, content server 102 may include a single server or similar system, or a plurality of servers and/or similar systems. For example, content server 102 may include a plurality of different servers and/or similar systems that may be employed individually or in combination to perform some or all of the functionality described herein with regard to content server 102.

Content server 102 may store or otherwise have access to content pages (e.g., webpages) 112. Content server 102 may serve content in response to receiving one or more content requests 116. For example, content server 102 may serve webpage 112 to browser 114 of user device 104 in response to receiving a corresponding content request 116 for webpage 112 from user device 104. It will be appreciated that certain embodiments are described in the context of a webpage, although embodiments may include any other form of content provided for presentation to a user. For example, content pages 112 may include maps provided on a mobile mapping device (e.g., a Global Positioning System (GPS) unit) or similar mobile client device.

Webpage 112 may include source code (e.g., HTML code) 118 that can be rendered by an application of a user device (e.g., browser 114) to effectuate display of the webpage to user. In some embodiments, webpage 112 may include or otherwise be associated with an ad-space 120. Ad-space 120 may include a location for the presentation of an advertisement. In the context of on-line advertising, for example, an ad-space may include a banner location, a pop-up window, or other location for the display of an ad. In some embodiments, a webpage may include any number of ad-spaces. For example, webpage 112 may include three ad-spaces 120 for the display of three different ads.

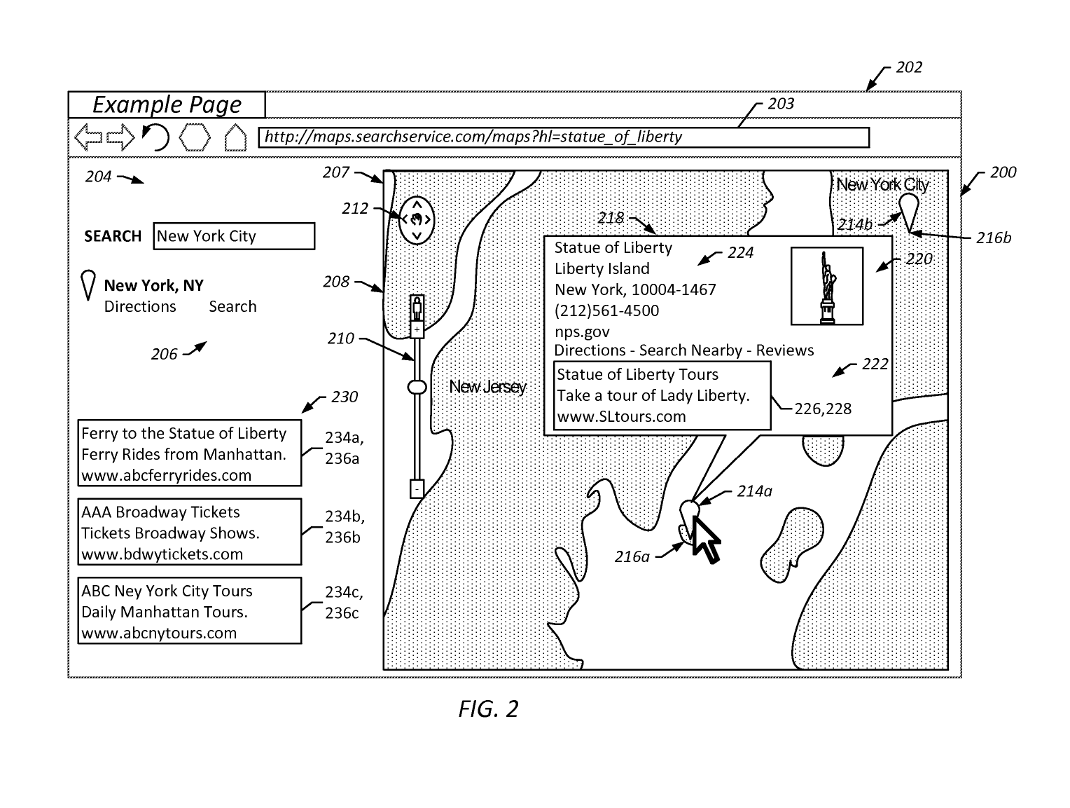

FIG. 2 is an illustration of an exemplary display of a webpage 200 in accordance with one or more embodiments of the present technique. Webpage 200 may be the same or similar to webpage 112. In some embodiments, webpage 200 may be displayed in a web-browser application window 202. Web-browser window 202 may include an address field 203 specifying a uniform resource locator (URL) address for displayed webpage 200. Web-browser window 202 may be illustrative of an exemplary web-browser window displayed on a graphical user interface of user device 104 via browser application 114.

In some embodiments, webpage 200 may include a page-content display area 204. Page-content display area 204 may include an area for the display of webpage page content (e.g., text, images, videos, etc.) 206 to be presented to a user. For example, where webpage 200 includes a “Map Page” page-content 206 may include a map 207 depicting a given geographic region 208, a search field 210, information about a geographic place, and so forth. In some embodiments, map 207 may include various interactive elements. For example, map 207 may include a zoom tool 210, a pan tool 212, interactive markers 214 and so forth. In some embodiments, zoom tool 210 may enable a user to select a level of detail (e.g., a zoom level of map 207 to be displayed. For example, where region 208 currently being displayed includes a city level view of about eight miles by eight miles (e.g., about sixty-four square miles), upon sliding zoom tool 210 upward, the zoom level may increase, resulting in map 207 displaying a smaller region, such as a zip code level view of about four miles by four miles (e.g., about sixteen square miles). In some embodiments, pan tool 212 may enable a user to pan the displayed region. For example, upon selection of a pan tool 212, the user may select within the displayed region 208 and drag the displayed portion of map 207 to the right such that the display pans to a portion of map 207 that is to the left of the originally displayed region 208.

In some embodiments, interactive markers 214 are disposed at a geographic location on map 207 corresponding to a geographic location of a given point of interest. For example, in the illustrated embodiment, a first marker 214a is displayed at a geographic location of a first point of interest 216a (e.g., the Statue of Liberty) and a second marker 214b is displayed at a geographic location of a second point of interest 216b (e.g., downtown New York City). In some embodiments, interaction with an interactive marker may provide for the display of additional information and/or generate a given response. For example, upon a user selecting marker 214a (e.g., clicking-on marker 214a, hovering over or near marker 214a, or the like) a pop-up/bubble window (e.g., bubble) 218 may be displayed.

The displayed bubble for a given marker may include location-content display and/or ad-content displays area. For example bubble 218 for marker 214a may include location-content display area 220 and/or ad-content display area 222. Location-content display area 220 may provide for the display of location content 224. Location content 224 may include information corresponding to the point of interest associated with the given marker. For example, location content 224 may include location information (e.g., an address), contact information (e.g., phone number, webpage, e-mail, or the like), images (e.g., photos), reviews, directions, and so forth corresponding to point of interest 216a (e.g., the Statue of Liberty). An ad-content display area may include one or more locations for the display of one or more ads. For example, ad-content display area 222 of bubble 218 may include an ad-space (e.g., ad-slot) 226 populated with an ad 228 for “Statue of Liberty Tours”.

In some embodiments, webpage 200 may include an ad-content display area. An ad-content display area may include one or more locations for the display of one or more ads. For example, webpage 200 may include ad-content display area 230 having three ad-spaces (e.g., ad-slots) 234a, 234b and 214c populated with ads 236a, 236b and 236c, respectively. For example, in the illustrated embodiment, ad-space 234a is populated with ad 236a for a “Ferry to the Statue of Liberty”.

In some embodiments, an ad to be displayed in an ad-space may be provided by ad-server 106. For example, ad-server 106 may provide one or more of ads 228, 236a, 236b and/or 236c to be displayed in ad-spaces 226, 234a, 234b and/or 234c, respectively. Ad-server 106 may include an entity that provides advertisement content to various entities of ad system 100. Ad-server 106 may be operated by an ad publisher, such as an ad-publisher/network. Although ad-server 106 is represented by a single box in FIG. 1, ad-server 106 may include a single server or similar system, or a plurality of servers and/or similar systems. For example, ad-server 106 may include a plurality of different servers and/or similar systems that may be employed individually or in combination to perform some or all of the functionality described herein with regard to content regard to ad-server 106.

In some embodiments, ad-server 106 serves ads in response to receiving a corresponding ad-request. For example, in response to receiving a given content request 116 for webpage 112 including an ad-space 120, content server 102 may submit a corresponding ad-request 123 to server 106. Ad-request 123 may request that ad-server 106 provide an ad to be displayed in ad-space 120 of webpage 112. In some embodiments, ad-request 123 may specify various types of information, such as an identifier/location of webpage 112 including ad-space 120, a pricing model, an ad-type, a point of interest and so forth. In response to ad-request 123, ad-server 106 may serve a suitable ad 122 to content server 102. Content server 102 may assemble webpage 112, including ad 122 to be presented in ad-space 120, and may serve webpage 112 and ad 122 to the requesting client (e.g., user device 104).

In some embodiments, ad-server 106 may serve an ad to user device 104 in response to receiving an ad-request. For example, in response to receiving, from user device 104, a given content request 116 for webpage 112, content server 102 may serve a webpage 112 including an ad-tag 124 to user device 104. Ad-tag 124 may include code that is embedded in source code 118 of a webpage 112. Ad-tag 124 may act as a placeholder for advertisements to be presented in ad-space 120. When ad-tag 124 is encountered during rendering of webpage 112 (e.g., execution of code 118 and/or code of ad-tag 124), ad-tag 124 may cause user device 104 to submit a given ad-request 123 to ad-server 106. In response to ad-request 123, ad-server 106 may serve ad 122 to user device 104 and/or browser 114. Browser 114 may embed ad 122 into ad-space 120. Browser 114 may provide for display of webpage 112, including ad 122 displayed in ad-space 120.

In some embodiments, an ad may be served directly to a requesting entity. For example, ad-server 106 may transmit the ad-content of a suitable ad 122 to content server 102, user device 104 and/or browser 114. In some embodiments, an ad may be served indirectly to a requesting entity. For example, ad-server 106 may identify ad 122 to the requesting entity and/or redirect the requesting entity to a source (e.g., another server) from which content of ad 122 can be retrieved. The requesting entity may locate and retrieve the identified add. For example, serving ad-request 123 may include transmitting an identity of ad 122 and/or where the add 122 is located, and content server 102, user device 104 and/or browser 114 may retrieve ad 122 from a given location (e.g., from another server, a remote storage location, a local memory, local cache, or the like).

Ad-publishers/networks may generate on-line ad revenue for an ad based on how an ad is served and/or how users interact with the ad. In some embodiments, revenue generated by ads is disbursed between various entities. For example, ad publishers may pay a portion of the ad revenue for an advertisement displayed in an ad-space of a webpage of a website, to the website owner. In some embodiments, various pricing models may be used to determine payments associated with ads. In a cost-per-impression (CPI) pricing model, advertisers may pay a given amount for each ad impression. An online ad impression may include a single appearance (e.g., display) of an ad on a webpage. In a cost-per-action (CPA) pricing model, advertisers may pay a fee upon the occurrence of each of one or more specified actions (e.g., click, purchase, lead, etc.) associated with the ad. Cost-per-action (CPA) pricing models may include various different pricing models, such as pay-per-click (PPC), cost-per-click-through (CPC), cost-per-sale (CPS), pay-per-lead (PPL), and other pricing models. In a pay-per-click (PPC) or cost-per-click-through (CPC) pricing model, advertisers may pay the ad-publisher/network a fee when the ad is clicked/selected by a user. In a cost-per-sale (CPS) pricing model, advertisers may pay the ad-publisher/network a fee if the ad is linked to a sale. For example, an advertiser may pay a given fee if a user navigates to the advertiser's website from an advertisement link and purchases an item on the advertiser's website. The above pricing models are intended to be exemplary. Other embodiments may include various revenue generation techniques and pricing models.

In some embodiments, selection of one or more ads to be served to satisfy an ad-request may be provided via an auction (“ad-auction”). An ad-auction may include submission/receipt of any number of bids associated with one or more ads intended to be presented in the ad-space associated with the ad-request. Execution of the ad-auction may identify winning bids and/or ads corresponding to the winning bids. The ads corresponding to the winning bids may be served to the requesting entity to satisfy the ad-request. For example, in response to receiving a given ad-request 123 relating to ad-space 120, ad-server 106 may obtain bids relating to add space 120, conduct an ad-auction based on the obtained bids, identify a winning bid and, where ad 122 corresponds to the winning bid, serve ad 122 to satisfy ad-request 123.

In some embodiments, bids submitted to an ad-auction are based on one or more bid-parameter-sets. Bid-parameter-sets may be specified by one more advertisers. For example advertiser 108 may supply one or more bid-parameter-sets 130 to ad-server 106. A given bid-parameter-set may include bid criteria 132, a bid amount 134, and a correspond ad 122. Bid criteria 132 may define conditions for submitting a corresponding bid. When assessing bids to be submitted to an ad-auction for an ad-space, ad-server 106 may filter a plurality of bid-parameter-sets 130 based on their bid criteria 132 to identify one or more matching bid-parameter-sets 130 for which a corresponding bid should be submitted to the ad-auction. Ad-server 106 may submit bids corresponding to each of the matching bid-parameter-sets 130 to the ad-auction.

Bid criteria 132 may specify one or more conditions that must exists for a bid to be submitted. If an ad-request is received for an ad-space that meets the bid criteria of a bid-parameter-set, a bid corresponding to the bid-parameter-set may be submitted to the ad-auction for the ad-space. If, however, an ad-request is received for an ad-space that does not meet the bid criteria of a given bid-parameter-set, a bid corresponding to the bid-parameter-set may not be submitted to the ad-auction for the ad-space.

In some embodiments, an advertiser may target advertisements to a particular audience by specifying certain bid criteria. Advertisers may specify bid criteria to allow bid-submission to auctions for ad-spaces that are more likely to be viewed by the intended audience and to restrict bid-submission to auctions for ad-spaces that are more less to be viewed by the intended audience. For example, where an advertiser desires to place an ad related to sports, the advertisers may specify bid criteria limiting bids to webpages relating to sports, potentially increasing the likelihood of their advertisement being presented to a “sports” audience. Bid criteria may enable advertisers to specify type of pricing models to control costs associated with on-line advertising.

Bid criteria of a bid-parameter-set may specify a required context of an ad-space. In some embodiments, bid criteria may require that one or more given keywords must appear within the webpage containing the ad-space for a bid for the ad-space to be submitted. For example, where bid criteria 132 of a given bid-parameter-set 130 specifies that a keyword of “sports” must be present on a webpage containing the ad-space for a bid to be submitted to an ad-auction for the ad-space, and ad-server 106 receives a given ad-request 123 for an ad-space 120 of a given webpage 112 and the given webpage 112 does not contain the word “sports”, a bid corresponding to the given bid-parameter-set 130 may not be submitted to an ad-auction for ad-space 120. Where bid criteria 132 of a given bid-parameter-set 130 specifies that a keyword of “sports” must be present on a webpage containing the ad-space for a bid to be submitted to an ad-auction for the ad-space, and ad-server 106 receives a given ad-request 123 for an ad-space 120 of a given webpage 112 and the given webpage 112 does contain the word “sports”, a bid corresponding to the given bid-parameter-set 130 may be submitted to an ad-auction for the given ad-space 120.

Bid criteria of a bid-parameter-set may specify a point of interest group. A point of interest group may specify one-or-more points of interest for which a bid corresponding to the bid-parameter-set is to be submitted. For example, in some embodiments, one or more bod-parameters sets may include a point of interest group 140 that specifies the “Statue of Liberty” as a point of interest. Upon receiving a request for an ad for a given ad-space 120 to be displayed to a user and receiving an indication of the user interacting with content relating to the “Statue of Liberty”, ad-server may identify given bid-parameter-sets 130 having matching bid criteria 132 including point of interest group 140 that specifies the “Statue of Liberty” as a point of interest. Ad-server 106 may generate and submit bids corresponding to each of the identified bid-parameter-sets 130 to an auction for the ad-space.

Bid criteria of a bid-parameter-set may specify a pricing model associated with an ad-space. In some embodiments, bid criteria may indicate one or more acceptable pricing models for which a bid is to be submitted. For example, where bid criteria 132 for a given bid-parameter-set 130 specifies bids are only to be submitted for ad-spaces having a cost-per-action (CPA) pricing model, and ad-server 106 receives a given ad-request 123 for a given ad-space 120 requiring a cost-per-impression (CPI) pricing model, a bid corresponding to bid-parameter-set 130 may not be submitted to an ad-auction for the ad-space. Where bid criteria 132 for a given bid-parameter-set 130 specifies that bids are to be submitted for ad-spaces having a cost-per-action (CPA) pricing models, and ad-server 106 receives a given ad-request 123 for a given ad-space 120 having a cost-per-action (CPA) pricing model, a bid corresponding to bid-parameter-set 130 may be submitted to an ad-auction for the given ad-space 120.

A bid-parameter-set may specify a bid amount 124. A bid amount may specify or otherwise be indicative of a maximum monetary amount that the advertiser is willing to pay for a given ad-space. For example, an advertiser may specify a bid amount 124 of $0.10, indicating that the advertisers is willing to submit a maximum bid of $0.10 for execution of a given event (e.g., impression, click-through, etc.) for the ad 122.

A bid-parameter-set may identify a corresponding ad 122 that is to be presented in an ad-space upon the bid corresponding to the bid-parameter-set winning the ad-auction for the ad-space. A bid-parameter-set may include one or a plurality of identified ads. For example, a given bid-parameter-set 130 may specify a single ad 122 that is to be served for presentation in the ad-space 120 in response to a bid corresponding to the given bid-parameter-set 130 winning the ad-auction for ad-space 120. A bid-parameter-set may specify multiple ads. For example, a given bid-parameter-set 130 may specify multiple ads 122, where one or more of the specified ads 122 are to be served for presentation in the ad-space 120 in response to a bid corresponding to the given bid-parameter-set 130 winning the ad-auction for ad-space 120.

Ads may be provided by advertisers. For example, upon specifying a given bid-parameter-set 130 including bid criteria 132 and/or a bid amount 134, advertiser 108 may identify one or more ads 122 corresponding thereto. In some embodiments, an advertiser may provide the ad itself. For example, advertiser 108 may provide, to ad-server 106, a file including the content of ad 122. Ad 122 may be stored by ad-server 106 in datastore 150. Ad-server 106 may directly serve ad 122 to a requesting entity when appropriate. For example, upon ad-server 106 receiving a given ad-request 123 for which ad 122 is to be provided, ad-server 106 may retrieve ad 122 from datastore 150 and transmit ad 122 to the requesting entity. In some embodiments, an advertiser may provide a reference to the ad (e.g., a location of the ad content corresponding to ad). For example, advertiser 108 may provide a file name of ad 122 and/or address indicative of a location where ad 122 is stored (e.g., an ad-location), such as an address to a server on network. Ads may be indirectly served to a requesting entity. For example, upon ad-server 106 receiving a given ad-request 123 for which ad 122 is to be provided, ad-server 106 may provide the file name and/or the ad-location (e.g., via a redirect) to the requesting entity. The requesting entity may use the ad-information to retrieve the corresponding content for ad 122.

Bid-parameter-sets may be obtained from a plurality of different advertisers. For example, ad-server 106 may receive multiple bid-parameter-sets 130 from any number of different advertisers 108. In some embodiments, an advertiser may submit a plurality of different bid parameter sets. For example advertiser 108 may submit a first bid-parameter-set 130 specifying first bid criteria, a first bid amount, a first ad, and a second bid-parameter-set 130 specifying second bid criteria, a second bid amount, a second ad. Some or all of the bid-parameter-sets 130 received may be stored in a database (e.g., datastore 150).

Ad-server 106 may consider some or all of the bid-parameter-sets submitted by advertisers when assessing suitable ads to be served in response to an ad-request. For example, upon receiving a given ad-request 123 for ad-space 120, ad-server 106 may assess bid criteria 132 for each provided bid-parameter-set 130 to determine, for each bid-parameter-set 130, whether or not a corresponding bid should be submitted to an ad-auction for ad-space 120. Ad-server 106 may determine whether or not a corresponding bid should be submitted to an ad-auction for ad-space 120 based on the bid criteria 132 (e.g., point of interest group, context, associated webpage, ad-space type, pricing models, and so forth). In some embodiments, ad-server 106 may filter out bid-parameter-sets 130 having bid criteria 132 that does not match and/or conflicts with one or more characteristics of ad-space 120, thereby identifying bid-parameter-sets 130 having bid criteria 132 “matches” (e.g., that does not conflict with) characteristics of ad-space 120. Ad-server 106 may generate auction bids corresponding to the matching bid-parameter-sets 130. For example, where a given bid-parameter-set 130 matches the ad-space 120, ad-server 106 may generate/submit a corresponding auction bid for the given bid-parameter-set 130 (e.g., a bid for bid amount 134) to an ad-auction for ad-space 120. Auction bids may be generated/submitted to the ad-auction for each of the bid-parameter-sets 130 determined to match ad-space 120.

An ad-auction for an ad-space may include an automated auction to identify winning auction bids from the auction bids submitted. In some embodiments, winning bids may include auction bids of the highest bid amount. For example, a first bid specifying a bid amount of $0.20 per click-through may win over a second bid specifying a bid amount of $0.10 per click-through. In some embodiments, winning bids may include auction bids that are expected to generate the highest ad-revenue. For example, a first bid specifying a payment of $0.10 per click-through may win over a second bid specifying a payment of $0.20 per click-through where it is determined that the ad associated with the first bid is four times more likely to generate a click-though and is, thus, more likely to generate a higher overall ad-revenue.

Ad-server 106 may identify and serve ads corresponding to the winning auction bids. For example, where an auction bid corresponding to a given bid-parameter-set 130 is identified as a winning auction bid of the ad-auction for ad-space 120, ad-server 106 may serve ad 122 of the given bid-parameter-set 130 to the requesting entity (e.g., content server 102 and/or user device 104). Ads corresponding to winning bids may be presented in one or more ad-spaces for display to a user. For example, ad 122 may be presented in ad-space 120 for display to user 111. Browser application 114 may render webpage 112 having ad 122 displayed in ad-space 120 to user 111 via graphical interface of user device 104.

In some embodiments, an ad-auction may include a plurality of winning bids. For example, a given ad-request 123 may include a request for three ads to be displayed in three separate ad-spaces 120 of a given webpage 112. Ad-server 106 may conduct an ad-auction in a manner similar to that discussed above, identifying three winning bids (e.g., a winning bid for each of the available ad-spaces). Ads corresponding to the three winning bids may be served for display in the three respective ad-spaces of the webpage. For example, three given ads 122 for three different bid-parameter-sets 130 corresponding to the winning bids may be served to fill three separate ad-spaces 120 of webpage 112.

In some embodiments, an ad selection process is automated such that it may be conducted in a rapid fashion. For example, in some embodiments, bid selection/filtering and/or the ad-auction may be executed by ad module 160 of ad-server 106. Bid selection/filtering and/or the ad-auction may be conducted within fractions of a second. In some embodiments, rapidly identifying suitable ads may enable ads to be served quickly, potentially reducing delay in presenting content to the user. For example, upon receiving, from browser 114 of user device 104, a given content request 116 request for a webpage, content server 102 may submit the given ad-request 123 to ad-server 106 for an ad to be displayed in ad-space 120 of a given webpage 112, and ad-server 106 may execute corresponding bid selection/filtering and/or a corresponding ad-auction to quickly identify a given ad 122 and serve it to content server 102, thereby allowing content server 102 to quickly assemble and serve the given webpage 112 (including the given ad 122 for ad-space 120) to browser 114 for display to user 111. As a further example, upon rendering webpage 112 with ad-tag 124, browser 114 of user device 104 may submit a given ad-request 123 to ad-server 106 for an ad to be displayed in ad-space 120 of a given webpage 112, ad-server 106 may execute the corresponding bid selection/filtering and/or a corresponding ad-auction to quickly identify a given ad 122 and serve it to browser 114, thereby allowing browser 114 to quickly render webpage 112 (including the given ad 122 for ad-space 120) for display to user 111. In some embodiments, bid selection/filtering and/or a corresponding ad-auction may include consideration of a user specified point of interest group (e.g., point of interest group 140) and/or other bid criteria.

A point of interest may include a geographic location, such as a landmark, business, city, state, or the like. A point of interest (POI) group 140 may be indicative of one or more points of interest (POIs). A point of interest group 140 for a given bid-parameter-set 130 may specify one or more points of interest for which a bid corresponding to the given bid-parameter-set 130 is to be submitted. In some embodiments, upon receiving a request for an ad to be displayed in an ad-space that is associated with a given point of interest, a bid corresponding to a given bid-parameter-set may be submitted to an ad-auction for the ad-space if the given point of interest associated with the ad-space corresponds with at least one of the one or more point of interests specified by the point of interest group of the given bid-parameter-set. For example, a given bid-parameter-set 130 may include a point of interest group 140 that specifies the Statue of Liberty as a point of interest for which a corresponding bid for an ad-space is to be submitted. Upon user 111 selecting an image of the Statue of Liberty displayed on a given webpage 112, or otherwise interacting with content associated with the Statue of Liberty (e.g., clicking on a marker for the Statue of Liberty displayed in a geographic map) a user device 104 may detect the user interaction with content associated with the Statue of Liberty and generate a corresponding ad-request 123 for an ad to be displayed in ad-space 120 of the given webpage 112. The ad-request may be indicative of user interaction with the Statue of Liberty point of interest. For example, the ad-request may include point of interest data, such as text string, indicative of the “Statue of Liberty”. Ad-server 106 may receive the request and identify one or more bid-parameter-sets 130 including a point of interest group 140 specifying the Statue of Liberty as a point of interest for which a corresponding bid for an ad-space is to be submitted, and may submit a bid corresponding to a given bid-parameter-set 130 to the ad-auction for the ad-space. Bids corresponding to bid-parameter-sets including a point of interest group that does not include the Statue of Liberty as a point of interest may not be submitted to the ad-auction for the ad-space.

In some embodiments, a point of interest group may specifically identify one or more points of interest for which a corresponding bid is to be submitted. For example, point of interest group 140 of a given bid-parameter-set 130 may specify that bids are to be submitted to an ad-auction for ad-spaces associated with three particular points of interest, “A”, “B” and “C”. Upon receipt of an ad-request for an ad-space that is not associated with points of interest “A”, “B” or “C” (e.g., point of interest “D”), a bid corresponding to the given bid-parameter-set 130 may not be submitted to an ad-auction for the ad-space. Upon receipt of an ad-request for an ad-space that is associated with points of interest “A”, “B” or “C” (e.g., point of interest “A”), a bid corresponding to the given bid-parameter-set 130 may be submitted to an ad-auction for the ad-space.

In some embodiments, a point of interest group may specifically identify one or more points of interest for which a corresponding bid is not to be submitted. For example, point of interest group 140 of a given bid-parameter-set 130 may specify that bids are not to be submitted to an ad-auction for ad-spaces associated with three particular points of interest, “D”, “E” and “F”. Upon receipt of an ad-request for an ad-space that is associated with points of interest “D”, “E” or “F” (e.g., point of interest “D”), a bid corresponding to the given bid-parameter-set 130 may not be submitted to an ad-auction for the ad-space. Upon receipt of an ad-request for an ad-space that is not associated with points of interest “D”, “E” or “F” (e.g., point of interest “A”), a bid corresponding to the given bid-parameter-set 130 may be submitted to an ad-auction for the ad-space.

In some embodiments, a point of interest group 140 may identify one or more point of interest types for which a corresponding bid is to be submitted. For example, bid criteria 132 for a given bid-parameter-set 130 may include a point of interest group 140 specifying that bids are to be submitted to ad-auctions for ad-spaces associated with a point of interest of a “landmark” type/category. Upon receipt of an ad-request for an ad-space associated with a point of interest having a type/category of “landmark”, a bid corresponding to the given bid-parameter-set 130 may be submitted to an ad-auction for the ad-space. Upon receipt of an ad-request for an ad-space associated with a point of interest having a type/category other than the specified type/category of “landmark” (e.g., having a type/category of “city”), a bid corresponding to the given bid-parameter-set 130 may not be submitted to an auction for the ad-space.

In some embodiments, a point of interest group may identify one or more point of interest types for which a corresponding bid is not to be submitted. For example, bid criteria 132 for a given bid-parameter-set 130 may include a point of interest group 140 specifying that bids are not to be submitted to ad-auctions for ad-spaces associated with a point of interest of a “park” type/category. Upon receipt of an ad-request for an ad-space associated with a point of interest having a type/category of “park”, a bid corresponding to the given bid-parameter-set 130 may not be submitted to an ad-auction for the ad-space. Upon receipt of an ad-request for an ad-space associated with a point of interest having a type/category other than the specified type/category of “park” (e.g., having a type/category of “landmark”), a bid corresponding to the given bid-parameter-set 130 may be submitted to an auction for the ad-space.

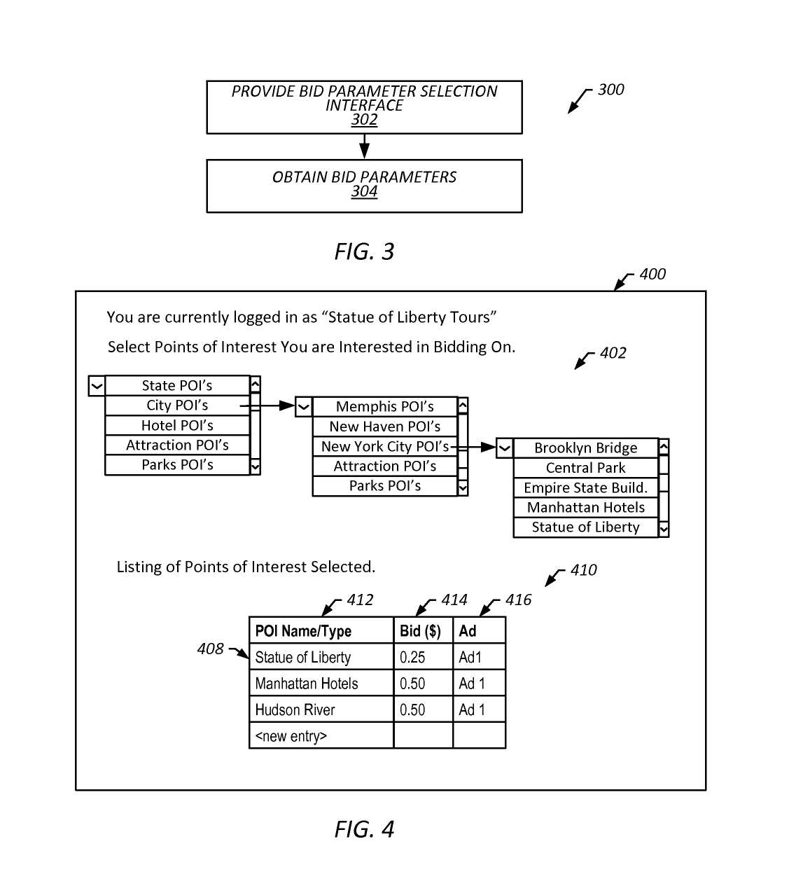

FIG. 3 is a flowchart that illustrates a method 300 of obtaining bid parameters, in accordance with one or more embodiments of the present technique. Method 300 may generally include providing a bid parameter selection interface and obtaining bid parameters. In some embodiments, ad-module 160 may provide for some or all of the operations described with regard to method 300.

Method 300 may include providing a bid-parameter selection interface, as depicted at block 302. Providing a bid parameter selection interface may include providing, via an on-line environment, an interface that enables an advertiser to interactively select bid parameters to define one or more bid-parameter-sets. For example, an on-line interactive interface for specifying bid criteria (e.g., keywords, point of interest groups, etc.), a bid amount, and/or one or more advertisements corresponding thereto may be provided for display to advertiser 108.

FIG. 4 is a diagram that illustrates an exemplary bid parameter selection interface 400 in accordance with one or more embodiments of the present technique. Bid parameter selection interface 400 may be provided by ad-server 106 via network 110, and may be displayed to advertiser 108 via a graphical user interface of an access device, such as a monitor of a computer system similar to that described in more detail below with regard to FIG. 7.

Bid parameter selection interface 400 may include a drill-down list 402 that enables a user to select from one or more pre-defined points of interest. For example, in the illustrated embodiment, advertiser 108 may select points of interest for which they would like to specify a corresponding bid-parameter-set. In some embodiments, upon selection of one or more points of interest via interface 400, a corresponding entry 408 may be added to a listing of selected points of interest 410. For example, an entry 408 may be provided for the “Statue of Liberty” and “Manhattan Hotels” via drill-down list 402. In some embodiments, a point of interest may be entered by the user. For example, where drill-down list 402 does not include a point of interest corresponding to the “Hudson River”, advertiser 108 may simply type “Hudson River” into an entry 408.

Each of entries 408 may include fields for point of interest name/type 412, a bid amount 414, and ad(s) 416. In some embodiments, bid parameters for each entry 404 may be provided by a user. For example, advertiser 108 may select the point of interest Name/Type via list 402 or otherwise specify the name/type, enter a bid amount, and identify a corresponding ad. A corresponding bid-parameter-set 130 may be generated for each entry 408.

Point of interest name/type 412 may include an identifier for a given point of interest. Point of interest name/type 412 may specify an identifier that uniquely identifies the given point of interest from other points of interest. For example, the first entry 408 of table 410 identifies the “Statue of Liberty”.

Point of interest name/type 412 may include an identifier for a given group of points of interest defined by a type/category. Point of interest name/type 412 may specify an identifier that uniquely identifies the given type/category of point of interest from other categories/types of points of interest. For example, the second entry 408 of table 410 identifies a group of points of interest of the type/category “Manhattan Hotels”.

Bid amount 414 may specify a maximum amount (e.g., in U.S. dollars) of a bid corresponding to the given entry. In some embodiments, bid amount 414 may also specify a corresponding pricing model. For example, bid amount 414 may specify a maximum bid of $0.50 per impression.

Advertisement(s) 416 for a given entry 408 may specify one or more advertisements to be served if a bid corresponding to the given entry wins an ad-auction for an ad-space. Advertisements 416 may include one or a plurality of identified ads. Where a single ad is specified (e.g., “Ad 1”), the ad may be served for presentation in the ad-space in response to a bid corresponding to the entry winning the ad-auction. Where multiple ads are specified (e.g. “Ad 2 or Ad 3”), one of the ads may be served for presentation in the ad-space in response to a bid corresponding to the entry winning the ad-auction.

In some embodiments, bid parameter selection interface 400 may provide for the entry of any number of bid parameters. For example, a bid parameter selection interface may enable an advertiser to define other bid criteria, such as keywords for bidding, and so forth.

Method 300 may include obtaining bid parameters, as depicted at block 304. Obtaining bid parameters may include an advertiser submitting and/or ad-server receiving one or more bid-parameter-sets provided via bid parameter selection interface 400. For example, upon advertiser 108 specifying and submitting the three entries 408 specified via interface 400, ad-server 106 may generate three different bid-parameter-sets, each corresponding to respective ones of the entries 408 of table 410.

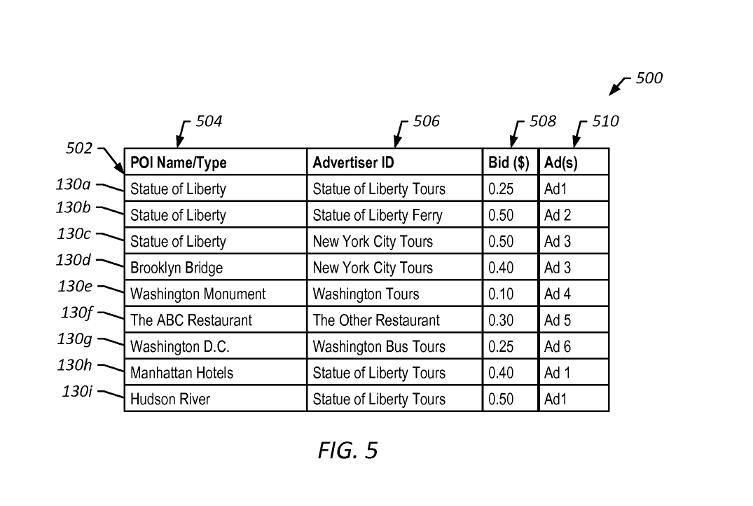

FIG. 5 illustrates a table 500 including a listing of exemplary bid-parameter-sets in accordance with one or more embodiments of the present technique. Each entry 502 of table 500 may include a point of interest Name/Type 504, an advertiser identifier (ID) 506, a bid amount 508, and an ad 510. Each entry 502 of table 500 may correspond to a separate bid-parameter-set 130a-130i. For example, point of interest Name/Type 504 may define a point of interest group 140 for a given bid-parameter-set, advertiser identifier (ID) 506 may identify an advertiser that submitted the entry for the given bid-parameter-set, bid amount 508 may define bid amount 134 for the given bid-parameter-set, and ad 510 may define ad(s) 122 for the given bid-parameter-set.

Table 500 may be generated based on entries provided from one or more advertisers via interface 400. For example, “point of interest Name/Type” 412, bid amount 414, and ad(s) 416 of the first entry 408 of table 410 may define point of interest group 140, bid amount 134 and ad 122, respectively, of a bid-parameter-set 130a. “Point of interest Name/Type” 412, bid amount 414, and advertisement(s) 416 of the second entry 408 of table 410 may define point of interest group 140, bid amount 134 and ad 122, respectively, of a bid-parameter-set 130h. “Point of interest Name/Type” 412, bid amount 414, and advertisement(s) 416 of the third entry 408 of interface 400 may define point of interest group 140, bid amount 134 and ad 122, respectively, of a bid-parameter-set 130i. Table 500 may include entries 502 corresponding to bid parameters submitted by any number of advertisers. For example, table 500 includes entries 502 submitted by “Statue of Liberty Ferry”, “New York City Tours” and so forth. The other bid-parameters may or may not be submitted by other advertisers via an interface similar to that of interface 400.

In some embodiments, obtaining bid parameters may include obtaining corresponding ads. Obtaining a corresponding ad may include obtaining the actual ad-content for storage. For example, referring to FIG. 4, where “Ad 1” specified by advertisement 416 of the first entry 408 of table 410 includes a banner add, ad-server 106 may receive from advertiser 108, corresponding image file(s) and/or HTML code for the banner ad. In some embodiments, obtaining ad-content may include ad-server 106 receiving an identity and/or a reference to a location of the ad-content. For example, where “Ad 1” specified by advertisement 416 of the first of entry 408 of table 410 includes a banner add, ad-server 106 may receive from advertiser 108, a name of the file (e.g., “Ad1.bmp”) and/or a location from which the ad may be retrieved.

It will be appreciated that method 300 is an exemplary embodiment of a method employed in accordance with techniques described herein. Method 300 may be may be modified to facilitate variations of its implementations and uses. Method 300 may be implemented in software, hardware, or a combination thereof. Some or all of method 300 may be implemented by ad module 160. The order of method 300 may be changed, and various elements may be added, reordered, combined, omitted, modified, etc.

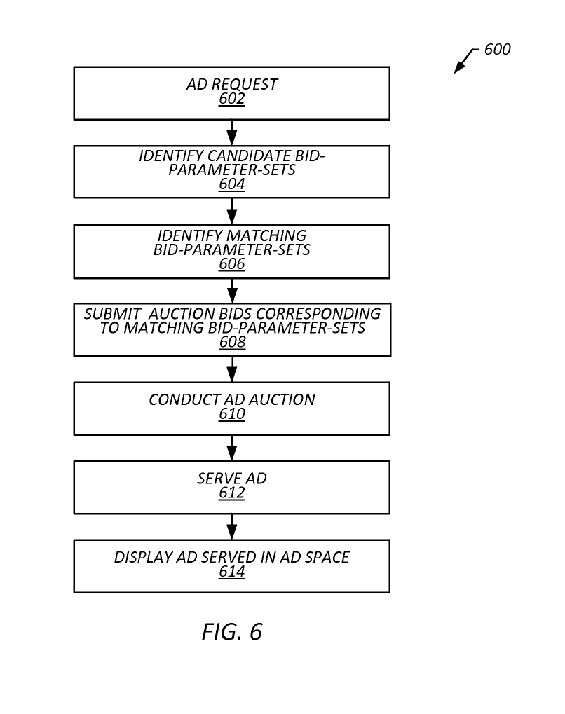

FIG. 6 is a flowchart that illustrates a method 600 for selecting, serving and displaying content in accordance with one or more embodiments of the present technique. Method 600 may include receiving an ad-request, as depicted at block 602. Receiving the ad-request may include ad-server 106 receiving a given ad-request 123 from browser 114 and/or content server 102. Ad-request 123 may include a request for ad-server 106 to serve a suitable ad to be displayed in ad-space 120 of content page 112. For example, ad-request 123 may include a request for ad-server 106 to serve a suitable ad to be displayed in ad-space 226 of bubble 218 and/or ad-spaces 234a, 234b and/or 234c of webpage 200.

In some embodiments, ad request 123 may be generated in response to display of content associated with a given point of interest. For example, ad request 123 may be generated in response to displaying webpage 200 (including the “State of Liberty” point of interest 216a) to user 111 via user device 104. In some embodiments, ad request 123 may be generated in response to user interaction with (e.g., selecting) content associated with a given point of interest. In some embodiments, ad-request 123 may be generated in response to a user selecting map content associated with a point of interest. For example, where webpage 200 is displayed to user 111 via user device 104, ad-request 123 may be generated in response to user 111 selecting marker 214a (e.g., clicking-on marker 214a, hovering over or near marker 214a, or the like) for the “Statue of Liberty” point of interest 216a. Ad-request 123 may request a suitable ad to be displayed in ad-space 226 of bubble 218 and/or ad-spaces 234a, 234b and/or 234c of webpage 200. In some embodiments, ad-request 123 may be generated in response to a user interaction with content associated with the point of interest. For example, ad-request 123 may be generated in response to user 111 selecting/opening an image of the Statue of Liberty via browser 114. In some embodiments, the content may be associated with the given point of interest via a tag. For example, an image of the Statue of Liberty may be entitled “Statue of Liberty” and/or may include a tag specifying the string “Statue of Liberty” embedded in the image file. In some embodiments, ad-request 123 may provide indication that the user has interacted with content corresponding to a point of interest and/or an indication of the point of interest with which the user has interacted. For example, ad-request 123 may include interaction data (e.g., “user_selection”) indicative of user interaction with a point of interest and/or point of interest data (e.g., “statue_of_liberty) indicative of the identity of the point of interest. In an exemplary embodiment, where a user selects a map marker (e.g., marker 214a) corresponding to the “Statue of Liberty”, a given ad-request 123 including the string “user_selection:statue_of_liberty” may be generated and/or submitted to ad-server 106, in response to the user selection of the map marker corresponding to the “Statue of Liberty”.

Method 600 may include identifying candidate bid-parameter-sets, as depicted at block 604. Identifying candidate bid-parameter-sets may include identifying and/or retrieving some or all of the bid-parameter-sets submitted by any number of different advertisers. For example, identifying candidate bid-parameter-sets may include retrieving and/or generating table 500 defining a plurality of bid-parameter-sets, as depicted and discussed with regard to FIG. 5.

Method 600 may include identifying matching bid-parameter-sets, as depicted at block 606. Identifying matching bid-parameter-sets may include filtering candidate bid-parameter-sets to identify bid-parameter-sets having bid-criteria that at least partially matches characteristics of the ad-request. For example, identifying matching bid-parameter-sets may include filtering the candidate bid-parameter-sets to identify one or more of the bid-parameter-sets having a point of interest group (e.g., point of interest Name/Type 504) that corresponds to the point of interest corresponding to the ad-request received at block 602. For example, filtering may identify bid-parameter-sets having a point of interest group that corresponds to the Statue of Liberty.

In some embodiments, filtering the candidate bid-parameter-sets may include determining, for each of the candidate bid-parameter-sets, whether the point of interest group for the given bid-parameter-set specifies a point of interest that corresponds to (e.g., matches) the point of interest associated with the ad-request. For example, where the given ad-request 123 specifies “Statue of Liberty” it may be determined that each of bid-parameter-sets 130a, 130b and 130c have a point of interest group 140 (e.g., point of interest Name/Type 504) that corresponds to “Statue of Liberty”. It may be determined that each of bid-parameter-sets 130d-130i, do not have a point of interest group 140 (e.g., point of interest Name/Type 504) that corresponds to “Statue of Liberty” point of interest specified by the given ad-request 123. In some embodiments, the bid-parameter-sets having a point of interest group specifying a point of interest that corresponds to (e.g., matches) the point of interest identified by the ad-request may be identified as matching bid-parameter-sets. For example, bid-parameter-sets 130a, 130b and 130c may be identified as matching bid-parameter-sets and/or bid-parameter-sets 130d-130i may be identified as non-matching bid-parameter-sets.

Although the illustrated embodiments discussed above may include an exact match of the terms of the point of interest associated with the ad-request and the terms of the point of interest group 140, other embodiments may not include an exact match. In some embodiments, other terms may be associated with point of interest group specified. For example, the term “Lady Liberty” may be associated with the point of interest “Statute of Liberty” such that upon a user interacting with an image entitled “Lady Liberty” and receiving a corresponding ad-request specifying “Lady Liberty”, identifying matching-bid parameter-sets may include identifying bid-parameter-sets 130a, 130b and 130c having a point of interest group 140 (e.g., point of interest Name/Type 504) corresponding to “Statue of Liberty”.

In some embodiments, filtering the candidate bid-parameter-sets may include determining, for each of the candidate bid-parameter-sets, whether other bid criteria for the given bid-parameter-set is satisfied. Other bid criteria may specify a required context of content associated with an ad-space (e.g., whether the webpage includes keywords as required by the bid criteria), a required pricing model (e.g., whether the ad-space includes a pricing model in accordance with a pricing model specified by the bid criteria), and so forth. Characteristics of the ad-request, ad-space and so forth, may be compared to corresponding requirements of the other specified bid criteria. In some embodiments, a bid-parameter-set may be considered a non-matching bid-parameter-set based on the failure to satisfy the other bid criteria. For example, despite having a point of interest group that corresponds to the point of interest (“State of Liberty”) associated with the given request 123, as discussed above, if bid-parameter-set 130c were to also include other bid-criteria that requires the page associated with the ad-space include the keyword “vacation”, and webpage 200 was associated with the ad-space, but did not include the keyword “vacation”, bid-parameter-set 130c may be identified as a non-matching based on the failure to satisfy the other bid-criteria. If a given bid-parameter-set 130 does not specify other bid criteria (e.g., where bid criteria 132 for the given bid-parameter-set 130 being assessed only specifies a point of interest group 140), the other bid criteria may be considered to be met or the determination may be skipped for the given bid-parameter-set 130.

Method 600 may include submitting auction bids corresponding to matching bid-parameter-sets, as depicted at block 608. Submitting auction bids corresponding to matching bid-parameter-sets may include submitting, to an ad-auction for the ad-space associated with the ad-request provided at block 602, bids corresponding to the matching bid-parameter-sets identified at block 606. For example, where bid-parameter-sets 130a, 130b and 130c have been identified as matching-bid parameter-sets for the given ad-request 123 for a suitable ad to be displayed in ad-space 226 of bubble 218 of webpage 200, bids corresponding to bid-parameter-sets 130a, 130b and 130c may be submitted to an ad-auction for ad-space 226. In some embodiments, the submitted bids may correspond to specified bid amount. For example, bids of $0.25/impression, $0.50/click-through and $0.50/click-through, corresponding to bid-parameter-sets 130a, 130b and 130c, respectively, may be submitted to an ad-auction for ad-space 226. In some embodiments, each bid may include other bid information, such as a pricing model for the given bid.

Method 600 may include conducting the ad-auction, as depicted at block 610. Conducting the ad-auction may include executing an automated auction to identify winning bids of the bids submitted at block 608. In some embodiments, winning bids may include those bids having the highest bid amount. For example, a first bid specifying a bod amount of $0.50 per click-through may win over a second bid specifying a bod amount of $0.10 per click-through. In some embodiments, winning bids may be associated with ads that are expected to generate the highest ad-revenue. For example, a first bid specifying a payment of $0.50 per click-through may win over a second bid specifying a payment of $0.50 per click-through, where it is determined that the ad associated with the first bid is four times less likely to generate a click-through and, thus, is more likely to generate a higher overall ad-revenue. In some embodiments, multiple bids may be identified as winning bids. For example, where the given ad-request 123 requests suitable ads to be displayed in ad-space 226 of bubble 218 and ad-space 234a of webpage 200, the ad-auction may identify two winning bids. In some embodiments, bids of $0.25/impression, and/or $0.50/click-through, corresponding to bid-parameter-sets 130a and/or 130b, respectively, may be determined to win the ad-auction.

Method 600 may include serving an ad, as depicted at block 612. Serving an ad may include ad-server 106 serving one or more ads corresponding to the winning bid. For example, where the bid of $0.25 corresponding to bid-parameter-set 130a is identified as a winning bid, ad-server 106 may serve “Ad 1” for display in ad-space 226 of bubble 218 of webpage 200. Where multiple winning bids have been identified, ads corresponding to each of the winning bids may be served. For example, referring at least to FIG. 2, where the bid of $0.25 corresponding to bid-parameter-set 130a and the bid of $0.50 corresponding to bid-parameter-set 130b are identified as winning bids, ad-server 106 may serve “Ad 1” for display in ad-space 226 of bubble 218 of webpage 200 and “Ad2” for display in ad-space 234a of webpage 200. Serving ads corresponding to one or more winning bids may satisfy the ad-request received at block 602.

Method 600 may include displaying the ad served, as depicted at block 614. Displaying the ad served may include displaying or otherwise presenting the served ad in a respective ad-space. For example, referring at least to FIG. 2, where the bid of $0.25 corresponding to bid-parameter-set 130a is identified as a winning bid, “Ad 1” (e.g., an ad 228 for “Statue of Liberty Tours”) may be displayed in ad-space 226 of bubble 218. Where the bid of $0.25 corresponding to bid-parameter-set 130a and the bid of $0.50 corresponding to bid-parameter-set 130b are identified as winning bids, “Ad 1” (e.g., an ad 228 for “Statue of Liberty Tours”) may be displayed in ad-space 226 of bubble 218, and “Ad2” (e.g., an ad 236a for “Ferry Rides to the Statue of Liberty”) may be displayed in ad-space 234a of webpage 200. In some embodiments, ads corresponding to losing bids are not served and/or displayed.

In some embodiments, display of an ad may be provided in a region previously not occupied by an ad. For example, upon user selection of marker 214a, an ad-request corresponding to ad-space 226 may be generated, a suitable ad (e.g., “Ad1”) may be identified (e.g., via an ad-auction) and served, and ad-space 226 of bubble 218 may be populated with “Ad 1” (e.g., ad 228 for “Statue of Liberty Tours”) at or near the time of display of bubble 218.

In some embodiments, display of an ad may be provided in a region previously occupied by an advertisement. For example, an ad may be displayed in ad-space 234a upon display of webpage 200. Upon subsequent user selection of marker 214a, an ad-request corresponding to ad-space 234a may be generated, a suitable ad (e.g., “Ad2”) may be served, and ad-space 234a may be populated with “Ad2” (e.g., ad 236a for “Ferry Rides to the Statue of Liberty”), replacing the previously displayed ad.

Method 600 is an exemplary embodiment of a method employed in accordance with techniques described herein. Method 600 may be may be modified to facilitate variations of its implementations and uses. Method 600 may be implemented in software, hardware, or a combination thereof. Some or all of method 600 may be implemented by ad module 160. The order of method 600 may be changed, and various elements may be added, reordered, combined, omitted, modified, etc.

Exemplary Computer System

FIG. 7 is a diagram that illustrates an exemplary computer system 1000 in accordance with one or more embodiments of the present technique. Various portions of systems and methods described herein may include or be executed on one or more computer systems similar to system 1000. For example, content server 102, user device 104, ad-server 106 and/or advertiser 108 described herein may include a configuration similar to at least a portion of computer system 1000. Further, methods/processes/modules described herein may be executed by one or more processing systems similar to that of computer system 1000.

Computer system 1000 may include one or more processors (e.g., processors 1010a-1010n) coupled to system memory 1020, an input/output I/O device interface 1030 and a network interface 1040 via an input/output (I/O) interface 1050. A processor may include a single processor device and/or a plurality of processor devices (e.g., distributed processors). A processor may be any suitable processor capable of executing/performing instructions. A processor may include a central processing unit (CPU) that carries out program instructions to perform the basic arithmetical, logical, and input/output operations of computer system 1000. A processor may include code (e.g., processor firmware, a protocol stack, a database management system, an operating system, or a combination thereof) that creates an execution environment for program instructions. A processor may include a programmable processor. A processor may include general and/or special purpose microprocessors. A processor may receive instructions and data from a memory (e.g., system memory 1020). Computer system 1000 may be a uni-processor system including one processor (e.g., processor 1010a), or a multi-processor system including any number of suitable processors (e.g., 1010a-1010n). Multiple processors may be employed to provide for parallel and/or sequential execution of one or more portions of the techniques described herein. Processes and logic flows described herein may be performed by one or more programmable processors executing one or more computer programs to perform functions by operating on input data and generating corresponding output. Processes and logic flows described herein may be performed by, and apparatus can also be implemented as, special purpose logic circuitry, e.g., an FPGA (field programmable gate array) or an ASIC (application specific integrated circuit). Computer system 1000 may include a computer system employing a plurality of computer systems (e.g., distributed computer systems) to implement various processing functions.

I/O device interface 1030 may provide an interface for connection of one or more I/O devices 1060 to computer system 1000. I/O devices may include any device that provides for receiving input (e.g., from a user) and/or providing output (e.g., to a user). I/O devices 1060 may include, for example, graphical user interface displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area (WAN), a cellular communications network or the like.

System memory 1020 may be configured to store program instructions 1100 and/or data 1110. Program instructions 1100 may be executable by a processor (e.g., one or more of processors 1010a-1010n) to implement one or more embodiments of the present technique. Instructions 1100 may include modules of computer program instructions for implementing one or more techniques described herein with regard to various processing modules. Program instructions may include a computer program (also known as a program, software, software application, script, or code). A computer program may be written in any form of programming language, including compiled or interpreted languages, or declarative/procedural languages. A computer program may include a unit suitable for use in a computing environment, including as a stand-alone program, a module, a component, a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier and/or a non-transitory computer readable storage medium having program instructions stored thereon. A tangible program carrier may include a propagated signal and/or a non-transitory computer readable storage medium. A propagated signal may include an artificially generated signal (e.g., a machine generated electrical, optical, or electromagnetic signal) having encoded information embedded therein. The propagated signal may be transmitted by a suitable transmitter device to and/or received by a suitable receiver device. A non-transitory computer readable storage medium may include a machine readable storage device, a machine readable storage substrate, a memory device, or any combination thereof. Non-transitory computer readable storage medium may include, non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices).

I/O interface 1050 may be configured to coordinate I/O traffic between processors 1010a-1010n, system memory 1020, network interface 1040, I/O devices 1060 and/or other peripheral devices. I/O interface 1050 may perform protocol, timing or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000, or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices and/or software that may perform or otherwise provide for the performance of the techniques described herein. For example, computer system 1000 may include a desktop computer, a laptop computer, a tablet computer, a server device, a client device, a mobile telephone, a personal digital assistant (PDA), a mobile audio or video player, a game console, a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” includes a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

1. A computer-implemented method, comprising:
providing, by the one or more computing devices, a user interface or receiving user-selected bid parameters from an advertiser, the user interface allowing one or more individual geographic points of interest to be selected or input by the advertiser;
obtaining, by the one or more computing devices, a bid-parameter-set that specifies the one or more individual geographic points of interest selected or input by the advertiser via the user interface;
receiving, by the one or more computing devices, a request for an advertisement, the request generated in response to user interaction with graphically displayed content corresponding to a geographic point of interest, wherein the request for an advertisement is generated in response to user interaction with a marker corresponding to the geographic point of interest and graphically displayed on a geographic map, the marker being one of a plurality of interactive markers on the geographic map;
determining, by the one or more computing devices, whether the geographic point of interest corresponds to at least one of the one or more individual geographic points of interest selected or input by the advertiser; and
submitting, by the one or more computing devices, to an auction for selecting an advertisement to serve the request for an advertisement, in response to at least determining that the geographic point of interest corresponds to at least one of the one or more individual geographic points of interest selected or input by the advertiser, an auction bid corresponding to the bid-parameter-set.

2. The method of claim 1, wherein the request for an advertisement comprises an indication that a user has interacted with graphically displayed content corresponding to the geographic point of interest.

3. The method of claim 1, wherein each of the plurality of interactive markers corresponds to a respective point of interest depicted in the geographic map, and wherein receiving a request for an advertisement comprises receiving a request for location content associated with the marker, the location content including at least one of a name, webpage, a phone number, or an address for the corresponding point of interest.

4. The method of claim 1, wherein a display window comprising information corresponding to the geographic point of interest is graphically displayed in association with the marker, and wherein receiving a request for an advertisement comprises receiving a request for an advertisement to be graphically displayed in the display window.

5. (canceled)

6. The method of claim 1, wherein user selection of graphically displayed content corresponding to the geographic point of interest comprises a user selection tool clicking on the graphically displayed content corresponding to the geographic point of interest.

7. The method of claim 1, wherein user selection of graphically displayed content corresponding to the geographic point of interest comprises a user selection tool hovering over the graphically displayed content corresponding to the geographic point of interest.

8. The method of claim 1, wherein the graphically displayed content corresponding to the geographic point of interest comprises tagged content having a tag corresponding to the geographic point of interest.

9. The method of claim 8, wherein determining whether the geographic point of interest corresponds to the at least one of the one or more individual. geographic points of interest selected or input by the advertiser comprises comparing the tag of the tagged content to an identifier of the one or more individual geographic points of interest.

10. The method of claim 1, further comprising:
obtaining another bid-parameter-set that specifies one or more individual geographic points of interest selected or input by a second advertiser;
determining whether the geographic point of interest corresponds to at least one of the one or more individual geographic points of interest selected or input by the second advertiser; and
excluding from submission to the auction, in response to at least determining that the geographic point of interest does not correspond to at least one of the one or more individual geographic points of interest selected or input by the second advertiser, an auction bid corresponding to the bid-parameter-set.

11. (canceled)

12. The method of claim 1, wherein the bid-parameter-set identifies a name of each of the one or more individual geographic points of interest selected or input by the advertiser.

13. The method of claim 1, wherein the bid-parameter-set identifies one or more categories of each of the one or more individual geographic points of interest selected or input by the advertiser.

14. (canceled)

15. The method of claim 1, further comprising:
conducting the auction;
determining that the auction bid corresponding to the bid-parameter-set is a winning bid of the auction; and
serving advertisement content corresponding to the bid-parameter-set to satisfy the request for an advertisement.

16. The method of claim 15, wherein serving the advertisement content comprises transmitting the advertisement content and transmitting location content for display with the advertisement content, the location content relating to a point of interest selected by the user by interacting with one of the plurality of interactive markers.

17. The method of claim 15, wherein serving the advertisement content comprises providing a reference to the advertisement content.

18. A non-transitory computer readable storage medium having computer-executable program instructions stored thereon, that are executable by a computer to cause steps comprising:
providing a user interface for receiving user-selected bid parameters from an advertiser, the user interface allowing one or more individual geographic points of interest to be selected or input by the advertiser;
obtaining a bid-parameter-set that specifies the one or more individual geographic points of interest selected or input by the advertiser via the user interface;
receiving a request for an advertisement, the request generated in response to user interaction with graphically displayed content corresponding to a geographic point of interest, wherein the request for an advertisement is generated in response to user interaction with a marker corresponding to the geographic point of interest and graphically displayed on a geographic map, the marker being one of a plurality of interactive markers on the geographic map;
determining whether the geographic point of interest corresponds to at least one of the one or more individual geographic points of interest selected or input by the advertiser; and
submitting to an auction for selecting an advertisement to serve the request for an advertisement, in response to at least determining that the geographic point of interest corresponds to the at least one of the one or more individual geographic points of interest selected or input by the advertiser, an auction bid corresponding to the bid-parameter-set.

19. An advertisement-server (ad-server) system, comprising:
a processor;
a memory; and
an auction module stored on the memory, the auction module is being configured to:
provide a user interface for receiving user-selected bid parameters from an advertiser, the user interface allowing one or more individual geographic points of interest to be selected or input by the advertiser;
obtain a bid-parameter-set that specifies the one or more individual geographic points of interest selected or input by the advertiser via the user interface;
receive a request for an advertisement, the request generated in response to user interaction with graphically displayed content corresponding to a geographic point of interest, wherein the request for an advertisement is generated in response to user interaction with a marker corresponding to the geographic point of interest and graphically displayed on a geographic map, the marker being one of a plurality of interactive markers on the geographic map;
determine whether the geographic point of interest corresponds to at least one of the one or more individual geographic points of interest selected or input by the advertiser; and
submit to an auction for selecting an advertisement to serve the request for an advertisement, in response to at least determining that the geographic point of interest corresponds to at least one of the one or more geographic points of interest, an auction bid corresponding to the bid-parameter-set.

20. A computer-implemented method for auctioning an advertisement space, the method comprising:
providing, by the one or more computing devices, a user interface for receiving user-selected bid parameters, the user interface allowing one or more individual geographic points of interest to be selected or input;
receiving, by the one or more computing devices, a request for an advertisement, the request generated in response to user interaction with graphically displayed content corresponding to a geographic point of interest, wherein the request for an advertisement is generated in response to user interaction with a marker corresponding to the geographic point of interest and graphically displayed on a geographic map;
assessing, by the one or more computing devices, a plurality of bid-parameter-sets, a first of the bid-parameter-sets comprising a first set of one or more individual geographic points of interest selected or input by a first advertiser via the user interface for which a corresponding auction bid is to be submitted, and a second of the bid-parameter-sets comprising a second set of one or more individual geographic points of interest selected or input by a second advertiser via, the user interface for which a corresponding auction bid is to be submitted;
determining, by the one or more computing devices, that the geographic point of interest does correspond to at least one of the one or more individual geographic points of interest of the first set of one or more individual geographic points of interest;
determining, by the one or more computing devices, that the geographic point of interest does not correspond to at least one of the one or more individual geographic points of interest of the second set of one or more individual geographic points of interest;
submitting, by the one or more computing devices, to an auction for selecting an advertisement to serve the request for an advertisement, in response to at least determining that the geographic point of interest does correspond to the at least one of the one or more individual geographic points of interest of the first set of one or more individual geographic points of interest, an auction bid corresponding to the first of the bid-parameter-sets; and
excluding, by the one or more computing devices, from submission to the auction for selecting an advertisement to serve the request for an advertisement, in response to at least determining that the geographic point of interest does not correspond to the at least one of the one or more individual geographic points of interest of the second set of one or more individual. geographic points of interest, an auction bid corresponding to the second of the bid-parameter-sets.
